(19) United States
(12) Patent Application Publication
(10) Pub. No.: US 2015/0096906 A1
(43) Pub. Date: Apr. 9, 2015

(54) BIOSENSOR WITH BYPASS ELECTRODES

(71) Applicant: Cilag GmbH International, Zug (CH)

(72) Inventors: Russell BAIN, Inverness (GB); Scott Sloss, Inverness (GB)

(73) Assignee: Cilag GmbH International, Zug (CH)

(21) Appl. No.: 14/047,821

(22) Filed: Oct. 7, 2013

(51) Int. Cl. G01N 27/30

(52) U.S. Cl. CPC G01N 27/307
USPC 205/792; 204/403.02

(57) ABSTRACT

A test strip comprising two electrodes having conducting surfaces facing inwardly toward each other in a portion of the test strip adjacent a sample chamber. A pair of spacers are disposed, each adjacent one side of the sample chamber, between the electrodes. The electrodes bypass each other at a proximal end of the test strip away from the sample chamber so that the conducting surfaces face outwardly away from each other to form electrical contact areas of the test strip.

### TECHNICAL FIELD

The present disclosure relates to structures, functions, and fabrication methods for a biosensor.

### BACKGROUND

Blood analyte measurement systems typically comprise an analyte test meter that is configured to receive a biosensor, usually in the form of a test strip. A user may obtain a small sample of blood typically by a fingertip skin prick and then may apply the sample to the test strip to begin a blood analyte assay. Because many of these systems are portable, and testing can be completed in a short amount of time, patients are able to use such devices in the normal course of their daily lives without significant interruption to their personal routines. A person with diabetes may measure their blood glucose levels several times a day as a part of a self management process to ensure glycemic control of their blood glucose within a target range.

Analyte detection assays find use in a variety of applications, including clinical laboratory testing, home testing, etc., where the results of such testing play a prominent role in diagnosis and management in a variety of disease conditions. Analytes of interest include glucose for diabetes management, cholesterol, and the like. In response to this growing importance of analyte detection, a variety of analyte detection protocols and devices for both clinical and home use have been developed.

One type of method that is employed for analyte detection is an electrochemical method. In such methods, a blood sample is placed into a sample-receiving chamber in an electrochemical cell that includes two electrodes, e.g., a counter and working electrode, and a redox reagent. The analyte is allowed to react with the redox reagent to form an oxidizable (or reducible) substance in an amount corresponding to the blood analyte concentration. The quantity or concentration of the oxidizable (or reducible) substance present is then estimated electrochemically by applying a voltage signal via the electrodes and measuring an electrical response which is related to the amount of analyte present in the initial sample.

The electrochemical cell is typically present on a test strip which is configured to electrically connect the cell to an analyte measurement device. While current test strips are effective, the size of the test strips can directly impact the manufacturing costs. While it is desirable to provide test strips having a size that facilitates handling of the strip, increases in size will tend to increase manufacturing costs where there is an increased amount of material used to form the strip. Moreover, increasing the size of the test strip tends to decrease the quantity of strips produced per batch, thereby further increasing manufacturing costs. Accordingly, there is a need for improved electrochemical test strip fabrication methods and structures to reduce material and manufacturing costs. Embodiments disclosed herein generally provide a co-facial test strip and method of manufacturing that minimize costs, and provides outside facing electrical contact areas for easy access by a hand held analyte measurement device such as a blood glucose test meter. The contact areas present completely accessible full strip width top and bottom layer electrodes to the meter. This allows for greater tolerances in the strip port connector of the meter and a simpler meter design because only one connection per side is required.

These and other embodiments, features and advantages will become apparent to those skilled in the art when taken with reference to the following more detailed description of various exemplary embodiments of the invention in conjunction with the accompanying drawings that are first briefly described.

### BRIEF DESCRIPTION OF THE DRAWINGS

The accompanying drawings, which are incorporated herein and constitute part of this specification, illustrate presently preferred embodiments of the invention, and, together with the general description given above and the detailed description given below, serve to explain features of the invention (wherein like numerals represent like elements).

FIG. 1A is a perspective view of an exemplary test strip during fabrication;

FIG. 1B is an exploded view of the test strip of FIG. 1A;

FIG. 1C is a side view of the test strip of FIG. 1A;

FIG. 1D is a top view of the test strip of FIG. 1A;

FIG. 1E is a top view of spatially separated top and base electrodes of the test strip of FIG. 1D;

FIGS. 2A-2D illustrate exemplary outlines of the top and base electrodes useful for embodiments of the test strip of FIG. 1A;

FIG. 3A illustrates an exemplary electrode web with a cutting pattern thereon;

FIG. 3B illustrates a side view of the electrode web of FIG. 3A;

FIG. 3C illustrates another exemplary electrode web with other cutting patterns thereon;

FIG. 4A illustrates a reagent layer and spacers on an electrode web;

FIG. 4B illustrates a side view of FIG. 4A;

FIG. 4C illustrates exemplary cutting patterns over the electrode web of FIG. 4A;

FIG. 5A illustrates an exemplary device and method for fabricating one embodiment of a test strip;

FIG. 5B illustrates exemplary steps for forming an embodiment of a test strip;

FIG. 6 illustrates a side view of an exemplary test strip having bypass electrodes; and

FIGS. 7A-7D are photographs of exemplary physical embodiments of test strips having top and base electrode outlines as illustrated in FIGS. 2A-2D, respectively.

### MODES OF CARRYING OUT THE INVENTION

Certain exemplary test strip embodiments will now be described to provide an overall understanding of the principles of the structure, function, manufacture, and use of the test strips and methods of fabrication disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure.

As used herein, the terms “patient” or “user” refer to any human or animal subject and are not intended to limit the systems or methods to human use, although use of the subject invention in a human patient represents a preferred embodiment.

The term “sample” means a volume of a liquid, solution or suspension, intended to be subjected to qualitative or quantitative determination of any of its properties, such as the presence or absence of a component, the concentration of a component, e.g., an analyte, etc. The embodiments of the present invention are applicable to human and animal samples of whole blood. Typical samples in the context of the present invention as described herein include blood, plasma, red blood cells, serum and suspensions thereof.

The term “about” as used in connection with a numerical value throughout the description and claims denotes an interval of accuracy, familiar and acceptable to a person skilled in the art. The interval governing this term is preferably ±10%. Unless specified, the terms described above are not intended to narrow the scope of the invention as described herein and according to the claims. The terms “top” and “base” as used herein are intended to serve as a reference for illustration purposes only, and that the actual position of the portions of the test strip will depend on its orientation.

The present invention generally provides an electrochemical biosensor, or test strip, having electrodes that communicate with an analyte measurement system or device. The biosensor is particularly advantageous as it offers a relatively small size, while providing a large surface area for ease of handling. The smaller size of the electrochemical biosensor may reduce manufacturing costs, as less material is required to manufacture it.

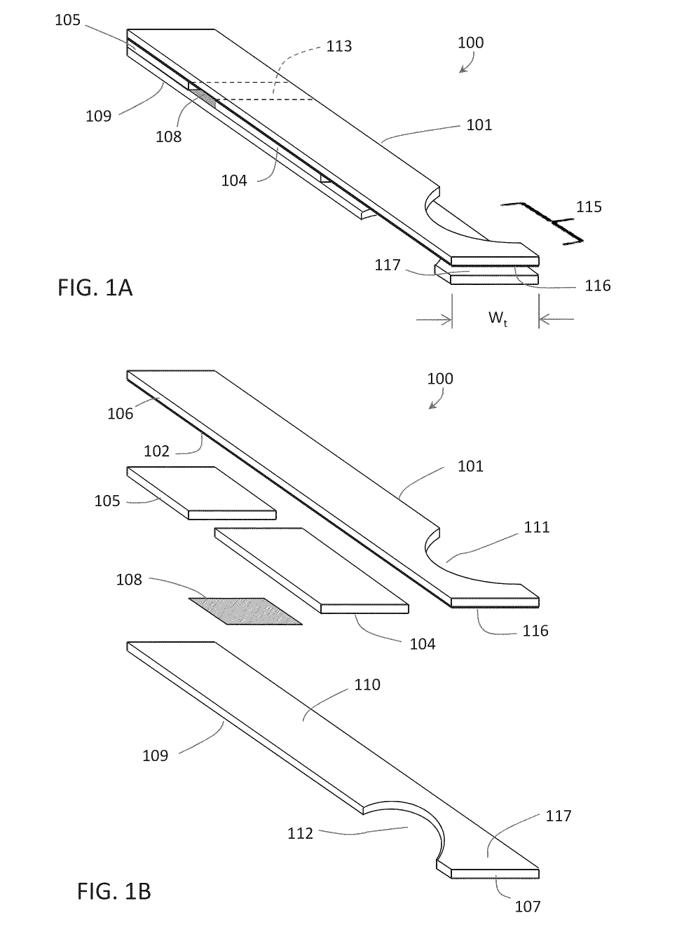

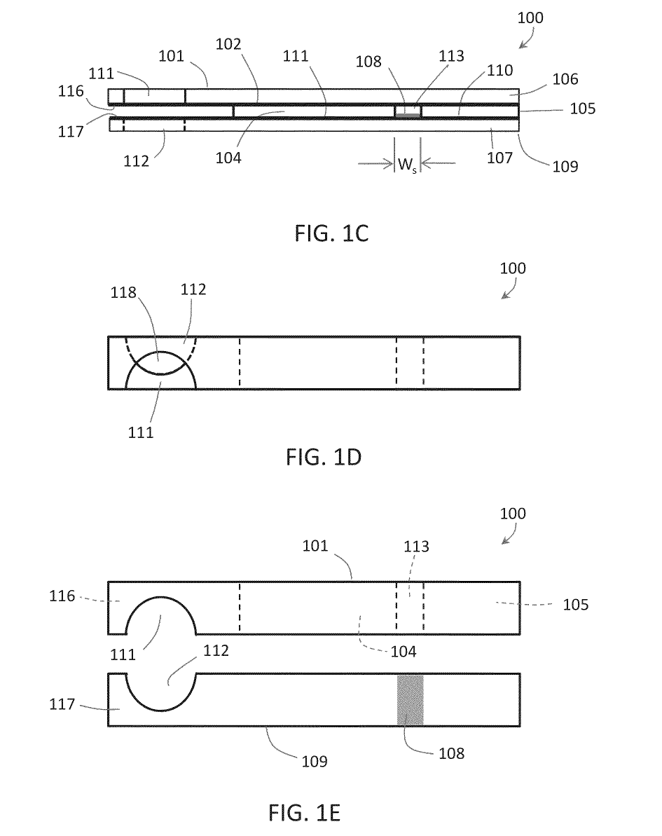

FIGS. 1A-1E illustrate one exemplary embodiment of an electrochemical biosensor 100, also referred to herein as a test strip. As shown, the test strip 100 generally includes top and base electrodes 101, 109, respectively, proximal and distal spacers 104, 105, respectively, and a reagent film 108, or layer, disposed between the spacers 104, 105 on the base electrode 109. The gap formed between the spacers 104, 105 and further defined by the top electrode 101 and the reagent layer 108 on the base electrode 109 forms the sample chamber 113 which functions as an electrochemical cell. The sample chamber extends across the width of the test strip Wₜ and provides an inlet at both ends which may be used for applying a sample therein. A person skilled in the art will appreciate that the test strip 100 can have various configurations other than those shown, and can include any combination of features disclosed herein and known in the art. Moreover, each test strip 100 can include a sample chamber 113 at various locations for measuring the same and/or different analytes in a sample.

The test strip 100 can have various configurations, but it is typically in the form of rigid, semi-rigid, or flexible layers 104-105, and flexible layers 106-107, having sufficient structural integrity to allow handling and connection to an analyte measurement system or device, as will be discussed in further detail below. The test strip layers 104-107 may be formed from various materials, including plastic, polyester, or other materials. The material of the layers 104-107, typically is one that is insulating (non-conductive) and may be inert and/or electrochemically non-functional, where they do not readily corrode over time nor chemically react with a sample applied to the sample chamber 113 of the test strip 100. The top electrode 101 includes a flexible insulating layer 106 and a flexible conductive material, or layer, 102 disposed on an inwardly facing surface thereof (facing the electrode 109). The base electrode 109 also includes a flexible insulating layer 107 and a flexible conductive material, or layer, 110 disposed on an inwardly facing surface thereof (facing electrode 101). The conductive layers should be resistant to corrosion wherein their conductivity does not change during storage of the test strip 100.

In the embodiment shown in FIGS. 1A-1E, the test strip 100 has a generally elongated, rectangular, planar shape wherein the conductive layers 102, 110 provide contact areas 116, 117 at a proximal end 115 of the electrodes for electrically communicating with electrical contacts of an analyte measurement system or device. The proximal ends 115 of the electrodes 101, 109 include substantially circular shaped cutouts 111, 112 which allow a bypass, or cross-over, orientation of the electrodes, as will be described below. The cutouts 111, 112 are exemplary cutout outlines and need not be limited to circular shaped cutouts, with further example shapes being described below. The cutout portions 111, 112 of the test strip 100 may be formed by a punch tool or other cutting tools. Embodiments of the methods described herein disclose steps for disposing the contact areas 116, 117 in an outward facing orientation for allowing easy electrical access to the electrodes 101, 109 using electrical contacts of an analyte measurement system or device. Such a configuration facilitates connection of the top and base electrodes 101, 109 to an analyte measurement device and allows the device to engage the electrodes and measure an analyte concentration of a fluid sample provided in electrochemical sample chamber 113. As illustrated in FIG. 1A, the contact areas 116, 117 are inwardly facing and may be difficult to engage for establishing electrical contact therewith without further modification.

The top and base electrodes 101, 109 include a substantially insulating and inert substrate, 106, 107, respectively, and have a conductive material disposed on one surface thereof 102, 110, respectively, to facilitate communication between the electrodes 101, 109 and an analyte measurement system or device. The top and base electrodes 101, 109 and the conductive material disposed thereon also each comprise a generally elongated, rectangular, planar shape. The electrically conducting layers 102, 110 may be formed from any conductive material, including inexpensive materials, such as aluminum, carbon, graphene, graphite, silver ink, tin oxide, indium oxide, copper, nickel, chromium and alloys thereof, and combinations thereof (e.g., indium doped tin oxide) and may be deposited, adhered, or coated on the insulating layers 106, 107. However, precious metals that are conductive, such as palladium, platinum, indium tin oxide or gold, can optionally be used. The conductive layer may be deposited onto the insulating layers 106, 107 by various processes, such as sputtering, electroless plating, thermal evaporation and screen printing. In one exemplary embodiment, the reagent-free electrode, e.g., the top electrode 101, is a sputtered gold electrode, and the electrode containing the reagent 108, e.g., the base electrode 109, is a sputtered palladium electrode. As discussed in further detail below, in use one of the electrodes can function as a working electrode and the other electrode can function as the counter/reference electrode. The electrically conducting layers may be disposed on the entire inward facing surfaces of the top and base electrodes 101, 109, or they may terminate at a distance (e.g., 1 mm) from the edges of the electrodes 101, 109 but the particular locations of the electrically conducting layers 102, 110, should be configured to electrically couple the electrochemical cell of the sample chamber 113 to an analyte measurement system or device.

In one exemplary embodiment, the entire portion or a substantial portion of the inwardly facing surfaces of the top and base electrodes 101, 109 are coated with the electrically conducting layers 102, 110 at a preselected thickness. When the electrochemical test strip is assembled, as shown in FIG. 1A, the top electrode 101 will be positioned such that at least a portion of the inwardly facing conductive surface 102 of the top electrode 101 and the inwardly facing conductive surface 110 of the base electrode 109 are in facing relationship, i.e. “co-facial”, with one another. A person skilled in the art will appreciate that top and base electrodes 101, 109 can be manufactured to include separate layers such as an insulating layer 106, 107 adhered to a conductive metallic sheet 102, 110, respectively, rather than forming a conductive coating on an insulating substrate.

To maintain electrical separation between the top and base conductive layers 102, 110, the test strip 100 may further include a spacer layer, comprising proximal and distal spacers 104, 105, which may also be double-sided adhesive spacers for securing to one another the top and base electrodes 101, 109, in a spaced relationship. The spacers 104, 105 can function to maintain the top and base electrodes 101, 109 at a distance apart from one another, thereby preventing electrical contact between the co-facial top and base conducting layers 102, 110. The spacers 104, 105 may be formed from a variety of materials, including rigid, semi-rigid, or flexible material with adhesive properties, or the spacers 104, 105 can include a separate adhesive applied thereon to attach the spacers 104, 105 to the inside surfaces of electrodes 101, 109. The spacer material may have a small coefficient of thermal expansion such that the spacers do not adversely affect the volume of the sample chamber 113. The spacers 104, 105 may have a width that can be substantially equal to a width Wₜ (FIG. 1A) of the electrodes 101, 109 and a length that is significantly less than either of the electrodes 101 or 109. The spacers 104, 105 may have various shapes and sizes, may be generally planar, square or rectangular, and can be positioned in various locations between the top and base electrodes 101, 109. In the embodiment shown in FIGS. 1A-1E, spacers 104, 105 are spatially separated by a distance Wₛ (FIG. 1C) to define sidewalls of the sample chamber 113. A person skilled in the art will appreciate that the location of the spacers, and the sample chamber defined thereby, can vary. Similarly, the test strip can also include electrical contact areas 116, 117 located anywhere on the conductive layers 102, 110, respectively, for coupling to an analyte measurement system or device. Non-limiting examples of ways in which adhesives can be incorporated into the various test strip assemblies of the present disclosure can be found in U.S. Pat. No. 8,221,994 of Chatelier et al., entitled “Adhesive Compositions for Use in an Immunosensor”, the contents of which is incorporated by reference as if fully set forth herein in its entirety.

The top and base electrodes 101, 109 may be configured in any suitable configuration in an opposed spaced apart relationship for receiving a sample. The illustrated reagent film 108 may be disposed on either of the top or base electrodes 101, 109 between the spacers 104, 105 and within the chamber 113 for coming into physical contact, and reacting, with an analyte in a sample applied thereto. Alternatively, the reagent layer can be disposed on multiple faces of the sample chamber 113. A person skilled in the art will appreciate that the electrochemical test strip 100, in particular the electrochemical cell formed thereby, may have a variety of configurations, including having other electrode configurations, such as co-planar electrodes. The reagent layer 108 can be formed from various materials, including various mediators and/or enzymes. Suitable mediators include, by way of non-limiting example, ferricyanide, ferrocene, ferrocene derivatives, osmium bipyridyl complexes, and quinone derivatives. Suitable enzymes include, by way of non-limiting example, glucose oxidase, glucose dehydrogenase (GDH) based onpyrroloquinoline quinone (PQQ) co-factor, GDH based on nicotinamide adenine dinucleotide co-factor, and FAD-based GDH. One exemplary reagent formulation, which would be suitable for making the reagent layer 108, is described in U.S. Pat. No. 7,291,256, entitled “Method of Manufacturing a Sterilized and Calibrated Test strip-Based Medical Device,” the entirety of which is hereby incorporated as if fully set forth herein by reference. The reagent layer 108 can be formed using various processes, such as slot coating, dispensing from the end of a tube, ink jetting, and screen printing. While not discussed in detail, a person skilled in the art will also appreciate that the various electrochemical modules disclosed herein can also contain a buffer, a wetting agent, and/or a stabilizer for the biochemical component.

As described above, the spacers 104, 105 and the electrodes 101, 109 generally define a space or gap, also referred to as a window, therebetween which forms an electrochemical cavity or sample chamber 113 for receiving a sample. In particular, the top and base electrodes 101, 109 define the top and bottom of the sample chamber 113 and the spacers 104, 105 define the sides of the sample chamber 113. The gap between the spacers 104, 105 will result in an opening or inlet extending into the sample chamber 113 at both ends. The sample can thus be applied through either opening. In one exemplary embodiment, the volume of the sample chamber can range from about 0.1 microliters to about 5 microliters, preferably about 0.2 microliters to about 3 microliters, and more preferably about 0.2 microliters to about 0.4 microliter. To provide the small volume, the gap between the spacers 104, 105 have an area ranging from about 0.005 cm² to about 0.2 cm², preferably about 0.0075 cm² to about 0.15 cm², and more preferably about 0.01 cm² to about 0.08 cm², and the thickness of the spacers 104, 105 can range from about 1 micron to 500 microns, and more preferably about 10 microns to 400 microns, and more preferably about 40 microns to 200 microns, and even more preferably about 50 microns to 150 microns. As will be appreciated by those skilled in the art, the volume of the sample chamber 113, the area of the gap between the spacers 104, 105, and the distance between the electrodes 101, 109 can vary significantly.

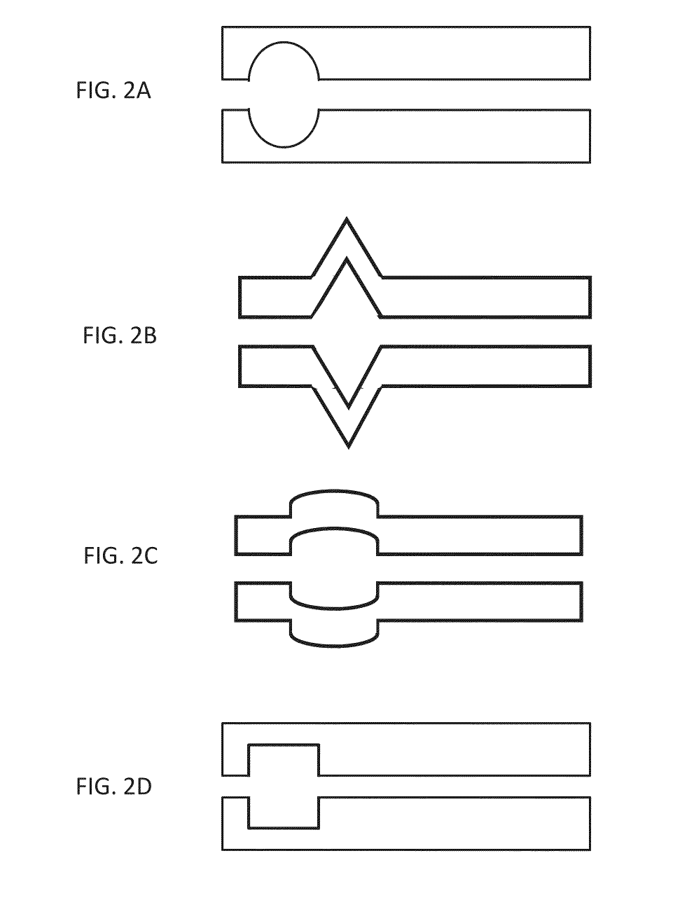

With reference to FIGS. 2A-2D, there are illustrated alternative shapes or configurations for exemplary pairs of electrodes 101, 109. The description above has been directed to the exemplary embodiment of electrodes 101, 109 as depicted in FIG. 2A having substantially circular cutouts. However, the descriptions above with reference to FIGS. 1A-1E apply equally to the electrode configurations as embodied in the shapes depicted in FIGS. 2B-2D which illustrate triangular cutouts, oval cutouts, and rectangular cutouts, respectively. Either electrode of the electrode pairs 2A-2D may be positioned as the top electrode 101 of the electrode pair 101, 109 in the descriptions above. The configurations of the exemplary electrode pairs 101, 109 as depicted in FIGS. 2A- 2D facilitate efficient fabrication methods and allow the cofacial contact areas 116, 117 at the proximal ends 115 of the electrode pairs to be arranged in a bypass, or cross-over, configuration as will be explained below.

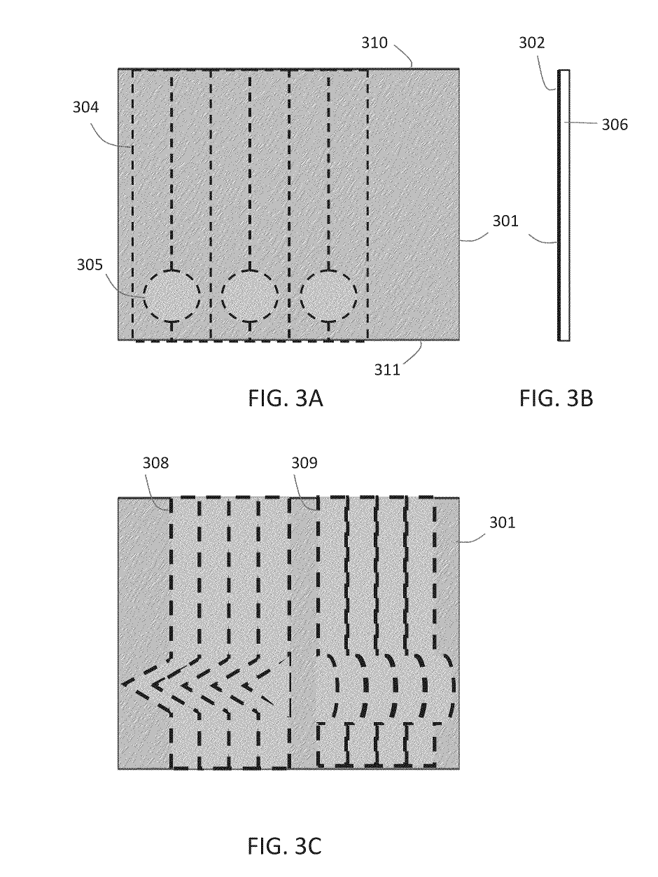

With reference to FIGS. 3A-3C, the material used for fabricating the top and base electrodes 101, 109 is formed as a continuous web 301, generally rectangular in shape having two opposite parallel edges 310, 311, and comprising an insulator layer 306 and a conductive layer 302 deposited thereon, as described above. The web 301 is cut according to tessellated cutting pattern 304 and through holes 305, as illustrated in FIGS. 3A-3B, which result in the electrode 101, 109 configurations as described herein with reference to FIGS. 1A-1E, and which correspond to the electrode configuration of FIG. 2A. The through holes 305 may be punched, or cut, through web 301 prior to, simultaneously with, or after the web 301 is cut according to the cutting pattern 304. With reference to FIG. 3C, the continuous web 301 may be cut according to tessellated cutting patterns 308 and 309, which correspond to, and result in, the fabrication of electrode 101, 109 configurations as illustrated in FIGS. 2B-2C, respectively. A reversed image cutting pattern for each of cutting patterns 308, 309 will be required to form an electrode pair as depicted in FIGS. 2B-2C. Because the cutting patterns 304, 308, 309 are immediately adjacent each other (tessellation) on the web 301, there is little wasted material and the cost of fabrication is correspondingly reduced.

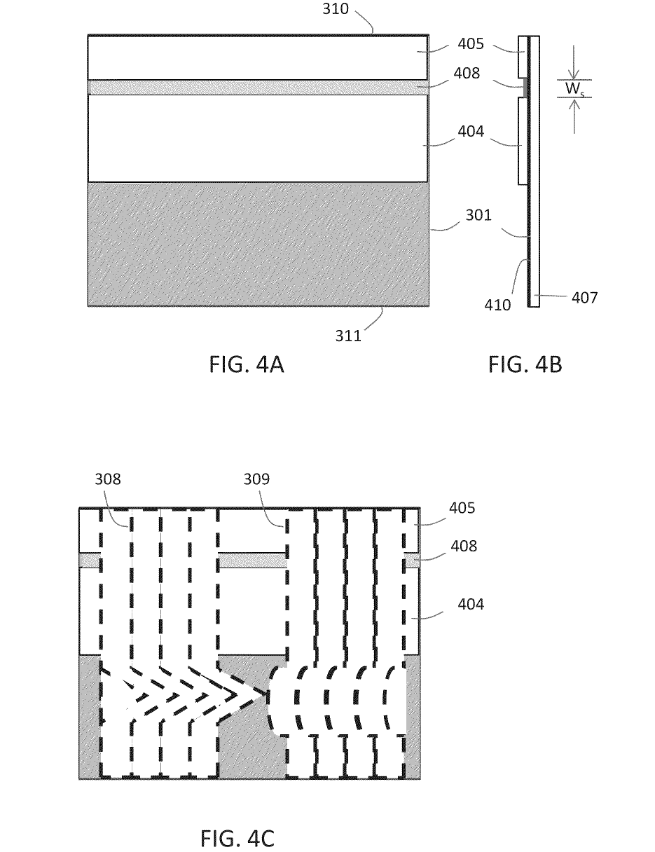

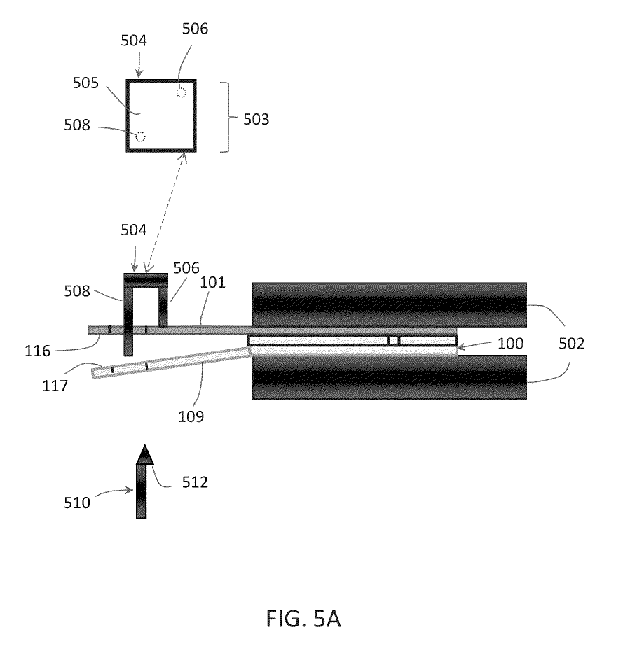

With reference to FIGS. 4A-4C, the web 301 may be prepared for forming a base (or top) electrode 109 having the reagent layer 408 and spacers 404, 405 deposited or adhered thereto prior to cutting the web 301. As a first step of fabricating the test strip 100, the web 301 may have a strip of reagent layer 408 applied thereto, which reagent layer 408 may require a drying step after application. The strip of the sample chamber reagent 408 is deposited in generally a straight line. The sample chamber reagent 408 is deposited along the conductive layer 410 such that it will align with the gap between the spacers 404, 405 when the spacers are applied thereto. The strip of the sample chamber reagent 408 may be applied such that it is slightly wider than the gap between the spacers 404, 405 when the spacers are applied. Spacers 404, 405 are then applied using adhesive spacers or using a separate adhesive applied previously to the spacers 404, 405. The pair of spacers 404, 405 may be deposited, laminated, or adhered onto the conductive layer 302 and are separated by a gap having a width Wₛ which eventually forms the sample chamber 113 having the width Wₛ. The spacers 404, 405 may be deposited in parallel to form a straight line gap therebetween. Alternatively, the spacers 404, 405, may be applied before the sample chamber reagent 408 layer is deposited therebetween.

After formation of the web 301 with reagent layer 408, and spacers 404, 405 assembled thereon, the bi-laminate web structure formed thereby may be cut according to the cutting pattern 304, 305 (FIG. 3A) or the cutting patterns 308, 309, as illustrated in FIG. 4C, or a combination thereof. The corresponding top (or base) electrode 101 cut, or singulated, from the web 301 according to the cutting patterns 308, 309 as illustrated in FIG. 3C may then be adhered to the base electrode 109 with reagent layer 408 and spacers 404, 405 thereon to assemble individual test strips 100. Alternatively, fully assembled electrode webs may be combined to form a trilaminate web structure comprising completed top and base electrodes with reagent 408 and spacers 404, 405 therebetween, and then cut to form fully assembled singulated test strips 100.

It should be noted that the fabrication steps just described may be modified in various combinations as is well known to those skilled in the art. For example, the steps just described for forming the electrodes 101, 109 may have a variety of configurations and sequences and are considered to be within the scope of the present disclosure. In another exemplary embodiment, the reagent layer may be applied, as necessary, to the top electrode instead of the base electrode. One advantage of the fabrication steps just described is that the method makes use of an interlocking, or tessellated, electrode web design that, when cut, forms electrode components, or completed test strips, without wasting fabrication materials.

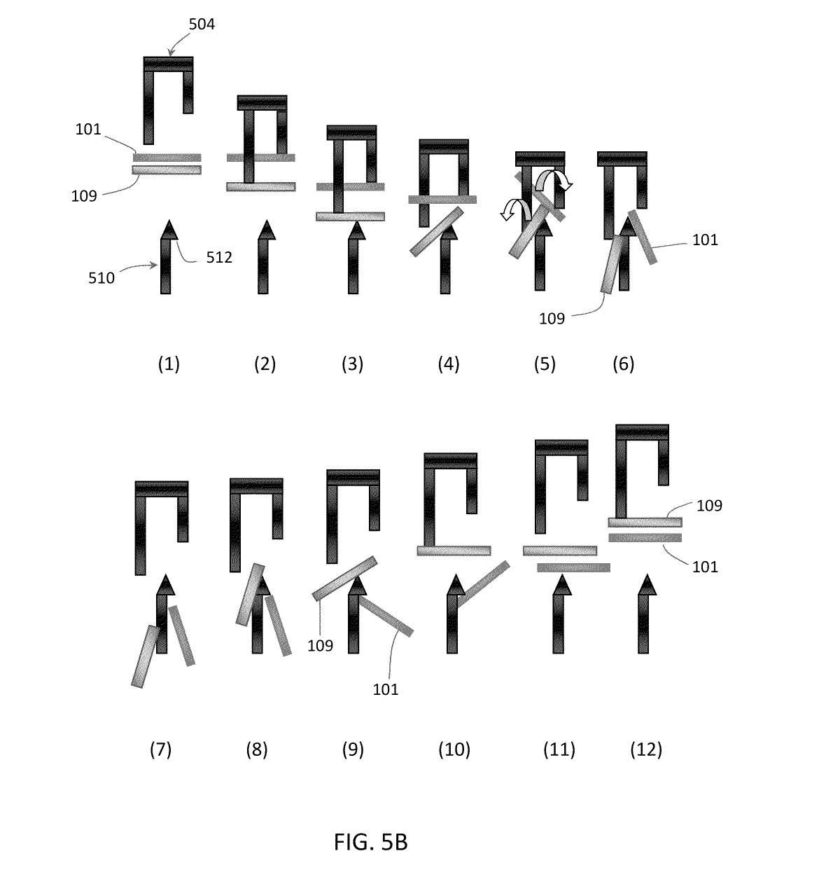

With reference to FIGS. 5A-5C there is illustrated an exemplary mechanism and inversion method for forming bypass electrodes 101, 109 on a test strip 100 having outwardly facing contact areas 116, 117. In a method as will now be described, the proximal end of the test strip 115 (FIG. 1A) comprising terminal ends of the flexible electrodes 101, 109 are engaged by the separation tool 504 and the spur 510 to invert the relative top/bottom position, or orientation, of the proximal ends 115 of the electrodes 101, 109 so that the formerly inward facing contact areas 116, 117 become outward facing to provide easy electrical engagement thereto. After completion of the method, outwardly facing contact areas 116, 117 may then each be engaged by one contact from an analyte measurement system or device to perform an analyte assay upon a sample applied to the sample chamber 113.

As shown in FIG. 5A, the mechanism comprises a clamp 502, a separation tool 504, and a spur 510. A distal end of the test strip 100 is secured within the clamp 502. The separation tool 504 comprises a short tine 506 and a long tine 508 secured to a base plate 505. The tines 506, 508 extend in a downward direction from the base plate 505, however, other orientations of the tool relative to the electrodes 101, 109 are considered part of the embodiments disclosed herein. The top view 503 of the base plate 504 illustrates that the short tine 506 and the long tine 508 are displaced from each other in both a horizontal and vertical direction, from the perspective of the top view 503. This displacement allows the long tine 508 to bypass the top electrode 101 through its cutout 111 and mechanically engage the base electrode 109 when the separation tool is moved in a downward direction. The mechanical engagement bends the lower electrode 109 downward as seen in FIG. 5A, due to the electrode's 109 flexible and easily deflectable material structure, as described above, until the short tine 506 makes contact with, and abuts, the flexible top electrode 101.

With reference now to FIG. 5B, the inversion method disclosed herein is illustrated in a twelve (12) step sequence. The first six steps (1)-(6) are shown in the upper portion of FIG. 5B while the remaining six steps (7)-(12) are shown in the lower portion of FIG. 5B. The first two steps (1)-(2) have been described above with reference to FIG. 5A, wherein the top electrode 101 is currently disposed above the base electrode 109. It should be noted that in the description that follows, the motion of the spur 510 relative to the separation tool 504 may be reversed such that the separation tool 504 remains stationary while the spur 510 moves in an upward/downward direction. Alternatively, both the spur 510 and the separation tool 504 may be caused to move in relative relationship as depicted in FIG. 5B. Step (3) demonstrates contact made by the spur 510 against the lower electrode 109 as the downward movement of the separation tool causes the spur to apply an upward pressure against the base electrode 109. As the downward movement by the separation tool continues, pressure is applied to the base electrode 109 and it begins to rotate, step (4). Continued movement cause the top electrode to do likewise in the opposite rotation, step (5). This motion continues, step (6), until both the upper electrode 101 and the lower electrode 109 have passed the top of the spur 510, and the separation tool begins moving upward, step (7). The upward movement allows the base electrode 109 to reform first, as the top electrode 101 is detained by the catch 512, step (8), formed at the top of the spur 510. Further upward movement of the separation tool 504 allows the base electrode 109 to reform first, steps (9)-(10). Continued upward movement of the separation tool 504 subsequently releases the top electrode 101 from the catch 512, step (11) followed by both the top electrode 101 and the base electrode 109 being reformed, i.e., inverted, in their modified orientation so that the top electrode 101 is now below the base electrode 109.

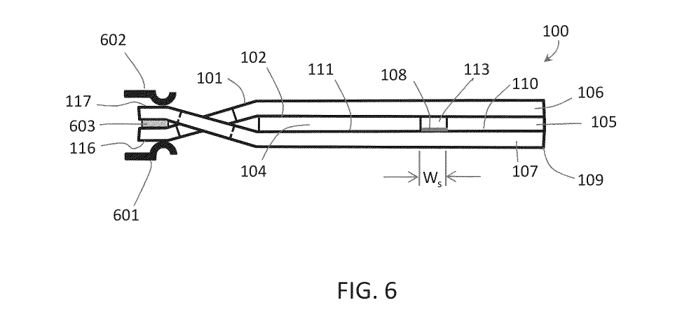

As illustrated in FIG. 6, the modified orientation of the proximal ends 115 of the top 101 and base electrodes 109 cause the upper electrode 101 contact area 116 to face outward (downward in the perspective of FIG. 6) as well as the lower electrode 109 contact area 117 (upward in the perspective of FIG. 6). As shown in FIG. 6, a pair of opposed electrical contacts 601, 602 of an analyte measurement system or device, such as a hand held test meter (not shown), may easily electrically engage the contact areas 116, 117 of the test strip 100. A spacer 603 is shown secured, such as by an adhesive, between the inverted proximal ends 115 of the top and base electrodes 101, 109 to maintain the contact areas 116, 117 in a spaced relationship to insure a good ohmic connection with the electrical contacts 601, 602.

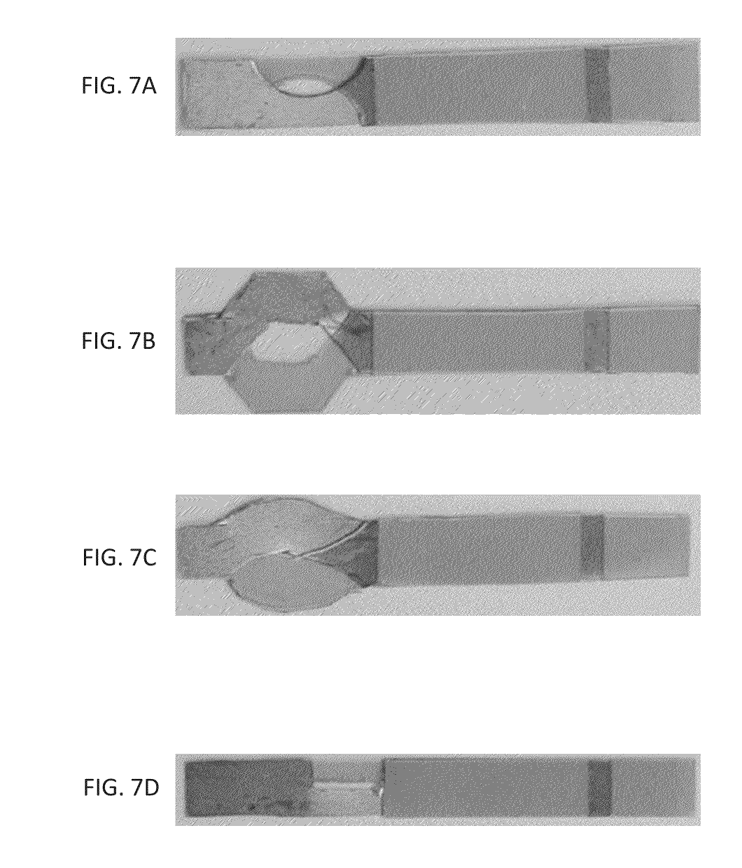

FIGS. 7A-7D illustrate photographs of laboratory made prototype biosensors corresponding to the top and base electrode outlines illustrated in FIGS. 2A-2D, respectively. The prototypes as illustrated have dimensions of about 3-4 mm by 30 mm, and comprise top-to-bottom layers as follows: (i) a top polyester layer or similar insulating layer; (ii) metal layer or metalized surface, or other conductive treatment; (iii) adhesive; (iv) spacer; (v) adhesive; (vi) electrochemical reagent layer; (vii) metalized layer; and (viii) a bottom polyester layer or similar insulating layer. The polyester layers have thicknesses of about 175 μm; the adhesive at about 25 μm; and the spacers at about 50 μm.

### PARTS LIST FOR FIGS. 1A-7D

100 test strip
101 top electrode
102 top electrode conducting layer
104 spacer—proximal
105 spacer—distal
106 insulating layer—top electrode
107 insulating layer—base electrode
108 reagent layer
109 base electrode
110 base electrode conducting layer
111 top electrode cutout
112 base electrode cutout
113 sample chamber
115 electrodes proximal end
116 top electrode contact area
117 base electrode contact area
118 cutout overlap
301 electrode web
302 conducting layer
304 cutting pattern
305 through hole
306 insulating layer
308 cutting pattern
309 cutting pattern
310 electrode web edge
311 electrode web edge
404 proximal spacer
405 distal spacer
407 insulating layer
408 reagent layer
410 conducting layer
502 clamp
503 top view—separation tool
504 separation tool
505 base plate
506 short tine
508 long tine
510 spur
512 catch
514 step—catch
601 top contact (prong)
602 bottom contact (prong)
603 spacer

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention, which are within the spirit of the disclosure or equivalent to the inventions found in the claims, it is the intent that this patent will cover those variations as well.

What is claimed is:

1. A test strip comprising:
a first electrode having a first conducting surface;
a second electrode having a second conducting surface, the first and second conducting surface facing inwardly toward each other across a sample chamber of the test strip;
a pair of spacers disposed between the first and second conducting surfaces adjacent the sample chamber; and
wherein the first and second electrodes bypass each other proximate an electrical contact region of the test strip such that the first and second conducting surfaces face away from each other to form outwardly facing electrical contact areas of the test strip.

2. The test strip of claim 1, further comprising a separator between and abutting the first and second electrodes at the outwardly facing electrical contact areas.

3. The test strip of claim 1, wherein the pair of spacers define a pair of walls of the sample chamber in the test strip.

4. The test strip of claim 3, wherein the first and second conducting surfaces of the first and second electrodes define a second pair of walls of the sample chamber in the test strip.

5. The test strip of claim 4, wherein at least one of the second pair of walls includes a reagent deposited thereon, and wherein the sample chamber is configured to receive a fluid sample therein, to generate a reaction between the fluid sample and the reagent, and to complete an electrical circuit between the first and second electrodes via the reacted fluid sample.

6. The test strip of claim 5, wherein the outwardly facing electrical contact areas of the test strip are configured to engage corresponding electrical contacts of an analyte meter when the test strip is inserted therein.

7. The test strip of claim 6, wherein the outwardly facing electrical contact areas and the first and second conducting surfaces are configured to electrically connect the electrical contacts of the analyte meter across the fluid sample in the sample chamber.

8. The test strip of claim 1, wherein the first electrode comprises a first insulating layer carrying the first conducting surface and the second electrode comprises a second insulating layer carrying the second conducting surface.

9. The test strip of claim 1, wherein the first and second electrodes each comprise a cutout portion for facilitating the first and second electrodes to bypass each other.

10. The test strip of claim 9, wherein the cutout portion is shaped as one of the group comprising a circular cutout, a triangular cutout, an oval cutout, and a rectangular cutout.

11. A test strip comprising:
a first electrode comprising a first insulating layer and a first conducting layer, the first electrode comprising a substantially elongated planar shape;
a second electrode comprising a second insulating layer and a second conducting layer, the second electrode comprising a substantially elongated planar shape substantially in parallel to the first electrode;
a pair of spacers disposed between and abutting the first and second conducting layers to maintain the first and second electrodes in a spaced apart relationship with one another, wherein the first and second conducting layers adjacent the spacers are inwardly facing; and
wherein the first and second conducting layers are outwardly facing at a proximal end of the electrodes away from the spacers.

12. The test strip of claim 11, wherein a portion of each of the first and second electrodes at the proximal ends of the electrodes comprise overlapping cutout portions configured to allow the first and second electrodes to bypass each other.

13. The test strip of claim 12, wherein the overlapping cutout portions are shaped as one of the group comprising a circular cutout, a triangular cutout, an oval cutout, and a rectangular cutout.

14. The test strip of claim 11, wherein the outwardly facing portion of the first conducting layer comprises a first contact area of the test strip, the outwardly facing portion of the second conducting layer comprises a second contact area of the test strip, and wherein the first and second contact areas face in opposite directions.

15. The test strip of claim 14, wherein the pair of spacers are separated by a gap, a portion of the first and second conducting layers face each other across the gap, and wherein said portions of the first and second conducting layers and said spacers define a sample chamber of the test strip.

16. The test strip of claim 15, wherein at least one of said portions of the first and second conducting layers comprise a reagent layer thereon to form an electrochemical cell for reacting with a sample applied to the sample chamber.

17. A method for determining an analyte concentration in a bodily fluid sample applied to an electrochemical-based analytical test strip comprising:
inserting the electrochemical-based analytical test strip into a hand-held test meter such that a first electrically conductive layer and a second electrically conductive layer of the electrochemical-based analytical test strip are in operable electrical contact with the hand-held test meter and wherein a proximal end of the first electrically conductive layer and a proximal end of the second electrically conductive layer are horizontally deflected past one another in an overlapping by-pass configuration;
applying a bodily fluid sample to the electrochemical-based analytical test strip; and
sensing an electrochemical response of the electrochemical-based analytical test strip using the hand-held test meter via the proximal ends of the first and second electrically conductive layers.

18. The method of claim 17, wherein the proximal ends of the first and second electrically conductive layers face outwardly away from each other.

19. The method of claim 18, wherein a distal end of the first electrically conductive layer and a distal end of the second electrically conductive layer face inwardly toward each other.

20. The method of claim 19, wherein the distal ends of the first and second electrically conductive layers face inwardly toward each other across a sample chamber of the electrochemical-based analytical test strip.
